(19) United States
(12) Patent Application Publication
(10) Pub. No.: US 2026/0356250 A1
(43) Pub. Date: Nov. 12, 2026

(54) MOVEMENT SUPPORT MECHANISM

(71) Applicant: Yazaki Corporation, Tokyo (JP)

(72) Inventors: Eri UEDA, Makinohara-shi (JP); Naoto KOGURE, Makinohara-shi (JP); Kosuke TOMOSADA, Makinohara-shi (JP)

(73) Assignee: Yazaki Corporation, Tokyo (JP)

(21) Appl. No.: 19/637,134

(22) Filed: Apr. 2, 2026

(30) Foreign Application Priority Data
May 7, 2025 (JP) 2025-077358

(51) Int. Cl. B60N 2/02; B60N 2/06; B60N 2/14; B60R 16/02

(52) U.S. Cl. CPC B60N 2/02253; B60N 2/06; B60N 2/14; B60R 16/0215

(57) ABSTRACT

A movement support mechanism is characterized by including a seat (movement portion); a support portion that supports the seat (movement portion) to be slidable and rotatable; a wire harness with an end portion that is arranged in the seat (movement portion) and another end portion that is arranged in a position separated from the seat (movement portion), wherein a length between both end portions is set to a length including a sliding excess length to make it possible to track the sliding of the seat (movement portion) and a rotational excess length to make it possible to track the rotating of the seat (movement portion); and a housing case that houses a portion at a side of the other end portion in the wire harness so as to be able to take in and out.

### TECHNICAL FIELD

The present invention relates to a movement support mechanism to support a predetermined movement portion.

### BACKGROUND ART

Conventionally, a movement support mechanism to support a vehicle seat as a movement portion to be slidable in a sliding direction along a travelling direction of the vehicle is known (for example, see Patent Document 1). According to the movement support mechanism described in Patent Document 1, it is possible for the seat to be supported so as to be slidable, and a wire harness is provided to electrically connect an electrical device mounted on the seat to other devices in the vehicle. This wire harness is provided so as to be able to track the sliding of the seat.

### CITATION LIST

### Patent Documents

Patent Document 1. JP 2022-152943A

### SUMMARY OF THE INVENTION

### Technical Problem

Here, in recent years, there has been a demand for the vehicle seat that it can not only slide but also rotate such as by reversing the front-to-rear direction. However, with regard to the wire harnesses, it is difficult for the conventional configurations being designed to track the sliding to track the rotating, and a movement support mechanism that enables the wire harness to track both the sliding and the rotating of the seat is desired.

Also, up to this point, the technical problem of the demand for the movement support mechanism that enables the wire harness to track both the sliding and the rotating of the seat has been explained using the example of a mechanism that supports a vehicle seat. However, although such technical problem is a typical technical problem within the vehicle seats, it is not limited thereto. That is, the above-mentioned technical problem can generally occur in any mechanism that supports a movement portion, as long as the mechanism is the movement support mechanism to support the movement portion in which an electrical device being electrically connected to other devices via the wire harness to operate is mounted.

Therefore, the present invention has been made in view of the above-mentioned technical problems, and an object thereof is to provide a movement support mechanism that can make a wire harness to track both a sliding and a rotating of a movement portion.

### Solution to Problem

In order to solve the above-described technical problem, a movement support mechanism is characterized by including a movement portion in which an electrical device is mounted to be electrically connected with another device to operate; a support portion that supports the movement portion to be slidable in a linear sliding direction and to be rotatable around a rotating axis intersecting with the sliding direction as a center; a wire harness with an end portion, that is used for connecting with the electrical device, being arranged in the movement portion and another end portion, that is used for connecting with the other device, being arranged in a position separated from the movement portion, wherein a length between both end portions is set to a length including a sliding excess length to make it possible to track the sliding of the movement portion and a rotational excess length to make it possible to track the rotating of the movement portion; and a housing case that houses a portion at a side of the other end portion in the wire harness so as to be able to take in and out.

### Effect of the Invention

According to the above-described movement support mechanism, it is possible to make the wire harness to track both the sliding and the rotating of the movement portion.

### BRIEF DESCRIPTION OF THE DRAWINGS

FIG. 1 is a schematic view showing a movement support mechanism according to an embodiment.

FIG. 2 is a schematic view showing the movement support mechanism shown in FIG. 1 in a state in which a seat (movement portion) is rotated by 180 degrees such that a front side and the rear side are reversed.

### DESCRIPTION OF EMBODIMENTS

Hereinafter, an embodiment of a movement support mechanism will be described.

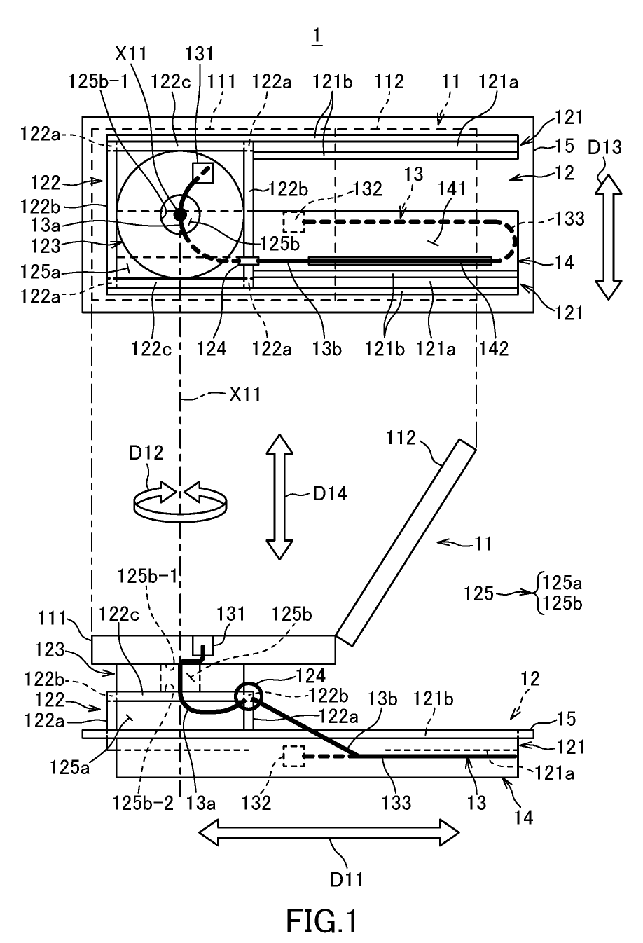

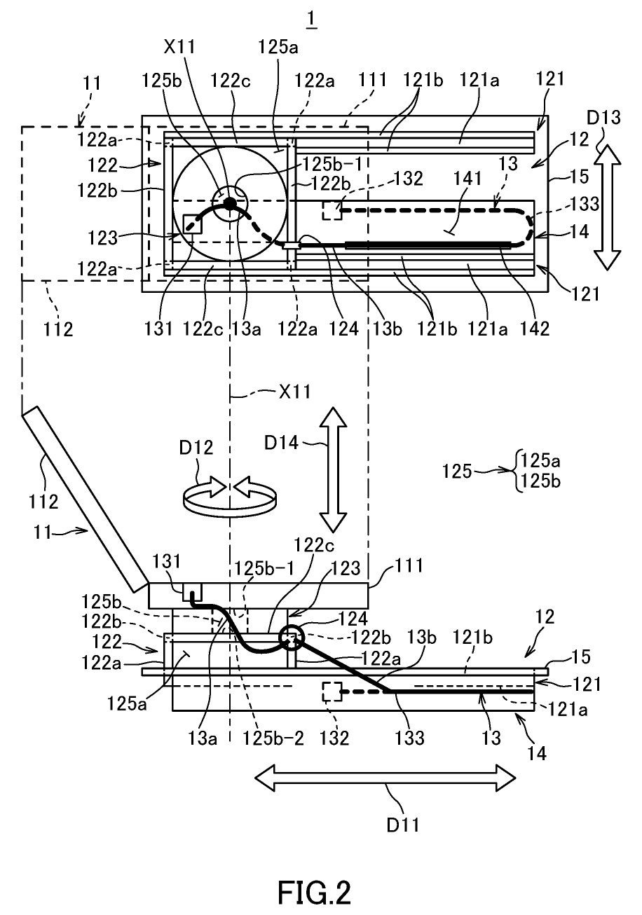

FIG. 1 is a schematic view showing a movement support mechanism according to an embodiment, and FIG. 2 is a schematic view showing the movement support mechanism shown in FIG. 1 in a state of the seat (movement portion) being rotated by 180 degrees such that the front-to-rear direction is reversed. In such FIGS. 1 and 2, with regard to the movement support mechanism 1, a plan view to show a seating portion 111 of the seat 11 as the movement portion and a side view to laterally show the seat 11 are schematically shown such that the routing state of a wire harness 13 can be seen.

The movement support mechanism 1 according to the present embodiment is a mechanism for supporting the seat 11 as the movement portion in a vehicle such as a passenger car so as to be slidable and rotatable as discussed below. Here, the sliding refers to a movement in a linear sliding direction D11 along a travelling direction of the vehicle, and the rotating refers to a rotating in a vertical direction of the vehicle, that is, in a rotating direction D12 around a rotating axis X11 that intersects with the sliding direction D11. Also, with regard to the rotating, it refers to the rotating by 360 degrees including a rotating by 180 degrees to make the front-to-rear direction to be reversed with respect to the travelling direction of the vehicle. Such movement support mechanism 1 includes a seat 11 as the movement portion, a support portion 12, a wire harness 13, and a housing case 14.

The seat 11 is a vehicle seat in which an electrical device that is electrically connected with other devices to operate is mounted. For example, as the electric devices mounted in this seat 11, a sensor that detects whether a passenger is seated, a heater that warms the seating portion 111 and a backrest 112 of the seat 11, and the like are included. Other devices being connected to these electrical devices include a power supply device that supplies power to the electrical devices, a control device that exchanges signals with the electrical devices, and the like.

The support portion 12 is a mechanism that supports the seat 11 so as to make it to be slidable in a linear sliding direction D11 and rotate by 360 degrees in a rotating direction D12 around a rotating axis X11, and it is mounted on a floor frame of the vehicle. The support portion 12 includes a pair of sliding rails 121, a sliding base 122, and a rotating base 123.

The sliding rail 121 is a portion extending in the sliding direction D11. The sliding rail 121 has a rail main body 121a in which a linear groove is formed in the sliding direction D11, and a pair of malls 121b that cover the groove opening of the rail main body 121a in a state in which the sliding base 122 is movable. The sliding rails 121 are parallelly arranged in a pair in an arrangement direction D13 orthogonal to the sliding direction D11 and the rotating axis X11, at an interval corresponding to a width dimension of the seat 11 in the arrangement direction D13.

The sliding base 122 is connected to the sliding rail 121 so as to be slidable in the sliding direction D11. The sliding base 122 is a member having a thin rectangular parallelepiped appearance. The sliding base 122 has a plurality of (four) leg frames 122a, two first frame portions 122b extending in a rod-like shape along the arrangement direction D13 of the sliding rail 121, and two second frame portions 122c extending in a rod-like shape along the sliding direction D11. The two first frame portions 122b and the two second frame portions 122c form a rectangular frame, and one leg frame 122a extends from each of the four corners of the rectangular frame toward the sliding rail 121. Regarding the four leg frames 122a, each two leg frames 122a are connected to the one sliding rail 121 such that each extending end portion is slidable.

The rotating base 123 is a portion that is disposed between the sliding base 122 and the seat 11 in an axial direction D14 of the rotating axis X11. The rotating base 123 has an annular appearance located inside a rectangular frame formed by the two first frame portions 122b and the two second frame portions 122c in a plan view when viewed from the axial direction D14. The rotating base 123 is connected to the sliding base 122 in a state of being fixed to the seat 11 so as to be rotatable around the rotating axis X11 as a center.

The support portion 12 includes the above-mentioned pair of sliding rails 121, the sliding base 122, and the rotating base 123 such that the seat 11 is supported to be slidable in the sliding direction D11 and rotatable around the rotating axis X11.

The wire harness 13 is a harness member having one end portion disposed in the seat 11 for connecting with an electrical device and the other end portion disposed at a position away from the seat 11 for connecting with another device. Such wire harness 13 includes a first connector 131 arranged inside the seat 11, a second connector 132 arranged at a position away from the seat 11 toward the floor frame of the vehicle, and a harness electric wire 133 connecting these two connectors. The first connector 131 is embedded in the seating portion 111 of the seat 11, and the second connector 132 is mounted inside the housing case 14. A length between both end portions of the wire harness 13, that is, the length of the harness electric wires 133, is set to a length that includes a sliding excess length to be able to track the sliding of the seat 11 and a rotational excess length to be able to track the rotating of the seat 11.

The housing case 14 is a case member that houses the side of the other end portion of the wire harness 13, that is, a portion at the side of the second connector 132 to make it able to take in and out. Such housing case 14 is a flat rectangular parallelepiped case that extends in the sliding direction D11 of the seat 11, and an outlet slit 142 from which the harness electric wire 133 of the wire harness 13 extends toward the side of the seat 11 is provided on an upper wall 141 thereof. Then, according to the present embodiment, the pair of the sliding rails 121 together with the housing case 14 are sandwiched between the floor frame and a carpet 15 covering the floor frame of the vehicle. A pair of slits through which the leg frames 122a of the sliding base 122, which moves along the sliding rails 121, are movable, and a slit through which the harness electric wire 133 that has passed through the outlet slit 142 of the housing case 14 can pass are provided in the carpet 15.

Here, according to the present embodiment, the wire harness 13 includes a rotating harness portion 13a including a rotational excess length on the side of the first connector 131, and a sliding harness portion 13b including a sliding excess length on the side of the second connector 132. Then, the above-described support portion 12 includes a harness fixing portion 124 and a harness housing portion 125.

The harness fixing portion 124 is a portion that fixedly retains a boundary portion between the rotating harness portion 13a and the sliding harness portion 13b , and it is provided on the sliding base 122. Specifically, the harness fixing portion 124 is provided on one first frame portion 122b extending in the arrangement direction D13 of the sliding rails 121 on the rear side in the vehicle travelling direction of the rectangular frame surrounding the rotating base 123. The harness fixing portion 124 is provided on this first frame portion 122b so as to fixedly retain the boundary portion in a state in which the wire harness 13 intersects with the first frame portion 122b.

The harness housing portion 125 is a space portion that houses the rotating harness portion 13a such that a portion of the rotating harness portion 13a near the boundary portion with the sliding harness portion 13b is rotatably movable while tracking the rotating of the seat 11. Furthermore, the harness housing portion 125 extends the side of the first connector 131 of the rotating harness portion 13a toward the seating portion 111 of the seat 11. According to the present embodiment, the harness housing portion 125 expands as from the sliding base 122 to the rotating base 123, and an internal space that is open toward the seat 11 is provided in the rotating base 123. More specifically, the harness housing portion 125 is a portion that makes the rotating harness portion 13a to pass through a rectangular space 125a on the side of the sliding base 122 and a cylindrical space 125b on the side of the rotating base 123 so as to house the rotating harness portion 13a. The rectangular space 125a on the side of the sliding base 122 is a space that is defined by being surrounded by the four leg frames 122a of the sliding base 122. The cylindrical space 125b on the side of the rotating base 123 is a cylindrical space formed in the rotating base 123 so as to cylindrically surround the rotating axis X11 while having a first opening 125b-1 opening toward the seat 11 and a second opening 125b-2 opening toward the sliding base 122.

According to the movement support mechanism 1 of the above-described embodiment, the wire harness 13 is set to have the following length in a state in which a portion, whose movement when moving away from and tracking the seat 11 tends to be noticeable, is housed the housing case 14. That is, the length of the wire harness 13 is set to include a sliding excess length that can track the sliding of the seat 11 and a rotational excess length that can track the rotating of the seat 11. According to such configuration, by setting the length as described above, the wire harness 13 can track both the sliding and the rotating of the seat 11. In other words, according to the movement support mechanism 1 described above, it is possible for the wire harness 13 to track both the sliding and the rotating of the seat 11.

Here, according to the present embodiment, the wire harness 13 includes a rotating harness portion 13a and a sliding harness portion 13b. The support portion 12 includes a harness fixing portion 124 that fixes and retains the boundary portion between the rotating harness portion 13a and the sliding harness portion 13b, and a harness housing portion 125 that houses a portion of the rotating harness portion 13a such that the portion of the rotating harness portion 13a is rotatably movable while tracking the rotating of the seat 11. Regarding the wire harness 13, the side of the first connector 131 extends from the harness housing 125 to the seat 11. According to such configuration, it is possible to house the sliding excess length of the sliding harness portion 13b so as to be able to take it in and out of the housing case 14 independent from the rotating harness portion 13a. Also, regarding the rotational excess length in the rotating harness portion 13a, it is possible to house it in the harness housing portion 125 independent from the sliding harness portion 13b and cause it to move while tracking the rotating of the seat 11. That is, regarding the wire harness 13 that can track both the sliding and the rotating of the seat 11, it is possible to divide the housing locations by the sliding excess length and the rotational excess length to effectively house the wire harness 13 and cause it to track the movement of the seat 11.

According to the present embodiment, the support portion 12 includes a sliding rail 121, a sliding base 122, and a rotating base 123. The harness fixing portion 124 is provided on the sliding base 122. The harness housing 125 expands from the sliding base 122 to the rotating base 123, and it is provided with an internal space that is open toward the seat 11 in the rotating base 123. According to such configuration, by dividing the support portion 12 into a mechanism portion related to sliding and a mechanism portion related to rotating, it is possible to utilize each mechanism portion so as to effectively provide the harness fixing portion 124 and the harness housing portion 125.

According to the present embodiment, the sliding rails 121 are parallelly arranged in a pair in an arrangement direction D13 that is orthogonal to the sliding direction D11. The harness fixing portion 124 is provided on one first frame portion 122b that extends along the arrangement direction D13 in the sliding base 122 so as to fixedly retain the above-described boundary portion in a state in which the wire harness 13 intersects with the first frame portion 122b. According to such configuration, the first frame portion 122b, which is orthogonal to the sliding direction D11, is used to fix the above-described boundary portion. By utilizing this first frame portion 122b, it is possible to make the sliding excess length in the sliding harness portion 13b to satisfactorily track the sliding of the seat 11 and make it possible to take it in and out from the harness housing portion 125.

According to the present embodiment, the sliding base 122 includes four leg frames 122a, wherein each is slidably connected to each of a pair of sliding rails 121. The harness housing portion 125 is a portion that passes the rotating harness portion 13a through a rectangular space 125a on the side of the sliding base 122, which is defined by the four leg frames 122a, and a cylindrical space 125b in the rotating base 123 so as to house it. According to such configuration, it is possible to make the rotational excess length to satisfactorily track the rotating of the seat 11 and move by utilizing the rectangular space 125a of the sliding base 122 and the cylindrical space 125b of the rotating base 123 in housing the rotating harness portion 13a.

The above-described embodiment merely shows a typical aspect of the movement support mechanism, and the movement support mechanism is not limited thereto, and it can be implemented in various modifications.

For example, according to the above-described embodiment, the movement support mechanism 1 that supports the vehicle seat 11 as a movement portion is exemplified as an example of the movement support mechanism. However, the movement support mechanism is not limited thereto, and it may be a mechanism that supports any object other than the seat as the movement portion, as long as it is a configuration to which an electrical device that operates by being electrically connected to other devices via a wire harness is mounted.

Also, according to the above-described embodiment, as an example of the support portion, the support portion 12 including the harness fixing portion 124 and the harness housing portion 125 is shown as an example. The harness fixing portion 124 is a portion that fixedly retains the boundary portion between the rotating harness portion 13a and the sliding harness portion 13b of the wire harness 13. Also, the harness housing 125 is a portion that houses a portion of the rotating harness portion 13a so as to make it to rotatably movable by tracking the rotating of the seat 11. However, the support portion is not limited thereto, and it may be a configuration that only supports a movement portion such as the seat 11 while not being involved in retaining the wire harness. In this case, the housing case may be configured to house not only the sliding excess length but also the rotational excess length in a manner that allows them to be taken in and out. However, as described above, by providing the harness fixing portion 124 and the harness housing portion 125 in the support portion 12, it is possible to divide the housing locations by the sliding excess length and the rotational excess length of the wire harness 13 to effectively house them.

Also, according to the above-described embodiment, as an example of the support portion, the support portion 12 in which the harness fixing portion 124 is provided on the sliding base 122 and the harness housing portion 125 is provided to have the internal space extending from the sliding base 122 to the rotating base 123 is shown as an example. However, the support portion is not limited thereto, and the specific aspects of the harness fixing portion and harness housing portion are not particularly limited. However, as described above, according to the above aspect that utilizes each the sliding mechanism and the rotating mechanism of the support portion 12, it is possible to effectively provide the harness fixing portion 124 and the harness housing portion 125.

Also, according to the above-described embodiment, as an example of the harness fixing portion, the harness fixing portion 124 that is arranged to fixedly retain the above-mentioned boundary portion on one first frame portion 122b in the arrangement direction D13 of the sliding base 122 is shown as an example. However, the harness fixing portion is not limited thereto, and the mounting position on the support portion can be freely determined. However, as described above, due to the harness fixing portion 124 that fixedly retains the boundary portion on the one first frame portion 122b in the arrangement direction D13, it is possible to make the sliding excess length to satisfactorily track the sliding of the seat 11 and take it in and out from the harness housing portion 125.

Also, according to the above-described embodiment, as an example of the slide rail in the support portion, the pair of sliding rails 121 are parallelly arranged in a pair at an interval corresponding to the width dimension of the seat 11 in the arrangement direction D13 orthogonal to the sliding direction D11 and the rotating axis X11 are shown as an example. However, the sliding rails are not limited thereto, and only a single sliding rail may be provided, and the single sliding rail may support the sliding base. Also, even if the sliding rails are provided in a pair, the distance therebetween may be set to any desired distance.

Also, according to the above-described embodiment, as an example of the harness housing portion, the harness housing portion 125 that passes the rotating harness portion 13a through the rectangular space 125a on the side of the sliding base 122 and the cylindrical space 125b on the side of the rotating base 123 so as to house it is shown as an example. However, the harness housing portion is not limited thereto, and there is not any particular limitation regarding how to utilize the specific space in the support portion. However, as described above, by utilizing the rectangular space 125a of the sliding base 122 and the cylindrical space 125b of the rotating base 123, it is possible to make the rotational excess length to satisfactorily track the rotating of the seat 11 and move.

In the above-described embodiment, the sliding base 122 slidably connected to the slide rail by four leg frames is exemplified as an example of the slide base. However, the slide base is not limited thereto, and even when the slide base is connected to the slide rail by leg frames, the number of leg frames may be any multiple number.

### REFERENCE SIGNS LIST

1 movement support mechanism
11 seat (movement portion)
12 support portion
13 wire harness
13a rotating harness portion
13b sliding harness portion
14 housing case
15 carpet
111 seating portion
112 backrest
121 sliding rail
121a rail main body
121b mall
122 sliding base
122a leg frame
122b first frame portion
122c second frame portion
123 rotating base
124 harness fixing portion
125 harness housing portion
125a rectangular space
125b cylindrical space
125b-1 first opening
125b-2 second opening
131 first connector
132 second connector
133 harness electric wire
141 upper wall
142 outlet slit
D11 sliding direction
D12 rotating direction
D13 arrangement direction
D14 axial direction
X11 rotating axis

What is claimed is:

1. A movement support mechanism, comprising:
a movement portion in which an electrical device is mounted to be electrically connected with another device to operate;
a support portion that supports the movement portion to be slidable in a linear sliding direction and to be rotatable around a rotating axis intersecting with the sliding direction as a center;
a wire harness with an end portion, that is used for connecting with the electrical device, being arranged in the movement portion and another end portion, that is used for connecting with the other device, being arranged in a position separated from the movement portion, wherein a length between both end portions is set to a length including a sliding excess length to make it possible to track the sliding of the movement portion and a rotational excess length to make it possible to track the rotating of the movement portion; and
a housing case that houses a portion at a side of the other end portion in the wire harness so as to be able to take in and out.

2. The movement support mechanism according to claim 1,
wherein the wire harness includes:
a rotating harness portion including the rotational excess length at the side of the end portion; and
a sliding harness portion including the sliding excess length at the side of the other end portion, and
wherein the support portion includes:
a harness fixing portion that fixedly retains a boundary portion of the rotating harness portion and the sliding harness portion; and
a harness housing portion that houses the rotating harness portion to make a portion thereof being near to the boundary portion to be rotatably moveable while tracking the rotating of the movement portion and makes the side of the end portion to extend toward the movement portion.

3. The movement support mechanism according to claim 2,
wherein the support portion includes:
a sliding rail that extends in the sliding direction;
a sliding base that is connected to the sliding rail to be slidable in the sliding direction; and
a rotating base that is arranged in an axial direction of the rotating axis to be sandwiched between the sliding base and the movement portion, wherein in a state of being fixed to the movement portion, the rotating base is connected to the sliding base to be rotatable around the rotating axis as a center,
wherein the harness fixing portion is arranged in the sliding base, and
wherein the harness housing portion is arranged to expand from the sliding base to the rotating base while having an internal space toward the movement portion in the rotating base.

4. The movement support mechanism according to claim 3,
wherein the sliding rails are parallelly arranged in a pair in an arrangement direction being orthogonal to the sliding direction and the rotating axis at an interval corresponding to a width dimension of the movement portion in the arrangement direction,
wherein the sliding base includes at least one rod-shaped frame portion along the arrangement direction, and
wherein the harness fixing portion is disposed to fixedly retain the boundary portion to the one frame portion in a state in which the wire harness intersects with the corresponding frame portion.

5. The movement support mechanism according to claim 3,
wherein the sliding rails are parallelly arranged in a pair in an arrangement direction being orthogonal to the sliding direction at an interval corresponding to a width dimension of the movement portion in the arrangement direction,
wherein the sliding base includes a plurality of leg frames connected to the pair of sliding rails so as to be slidable respectively,
wherein a cylindrical space cylindrically surrounding the rotating axis while a first opening opens toward the movement portion and a second opening opens toward the sliding base is formed in the rotating base, and
wherein the harness housing portion is a portion that houses the rotating harness by making the rotating harness to pass across a space at the side of the sliding base that is surrounded and defined by the plurality of leg frames and a cylindrical space in the rotating base.

6. The movement support mechanism according to claim 1,
wherein the movement portion is a seat mounted in a vehicle,
wherein the support portion is a mechanism to support the seat arranged on a floor frame in the vehicle to be slidable in direction along a travelling direction of the vehicle as the sliding direction and to be rotatable around an axis along a vertical direction of the vehicle as the rotating axis,
wherein the wire harness is a harness to electrically connect the electrical device mounted in the seat to the other device in the vehicle, and
wherein the housing case is a portion arranged together with the support portion on the floor frame.
